(19) United States
(12) Patent Application Publication
(10) Pub. No.: US 2007/0160033 A1
(43) Pub. Date: Jul. 12, 2007

(54) Method of providing a reliable server function in support of a service or a set of services

(76) Inventors: Marjan Bozinovski, Skopje (MK); Robert Seidl, Konigsdorf (DE)

Correspondence Address: MORRISON & FOERSTER LLP, 1650 TYSONS BOULEVARD, SUITE 400, MCLEAN, VA, 22102, US

(21) Appl. No.: 10/587,754

(22) PCT Filed: Jun. 29, 2004
(86) PCT No.: PCT/EP04/07050

§ 371 Date: Jul. 28, 2006

(51) Int. Cl. H04L 12/66

(52) U.S. Cl. 370/352

(57) ABSTRACT

The invention relates to a method of providing a reliable server function in support of a service, such as internet-based application, the server function provided by a Server Pool (SP) with one or more Pool Elements (PE1, PE2), each of the Pool Elements (PE1, PE2) being capable of supporting the service/s. where the performance, reliability and availability of the server function is improved over the existing methods, by sending status information related to the operational status of at least one of the pool elements (PE1, PE2) from a name server (NS) to the pool user (PU).

### CLAIM FOR PRIORITY

This application is a national stage of International Application No. PCT/EP2004/007050 which was filed on Jun. 29, 2004.

### TECHNICAL FIELD OF THE INVENTION

The invention relates to a method of providing a reliable server function in support of a service or a set of services, such as internet-based applications.

### BACKGROUND OF THE INVENTION

To increase availability and reliability for accessing services provided via server-based functions, for example, internet-based applications, it has become increasingly popular to provide a pool of servers instead of only one server. Each of the servers of the Server Pool, called Pool Elements, is capable of supporting the requested service or set of services.

In order to support high performance, availability, and scalability of the applications, it is required to keep track of what servers are in the pool and are able to receive requests, and a way for the client to bind to a desired server. These topics are discussed in the IETF (Internet Engineering Task-Force) Working Group “Reliable Server Pooling,” called the RSerPool working group. An architecture for reliable server pooling is being standardized within this working group, see for example, the definition of a reliable server pooling fault-tolerant platform described in Tuexen et al., “Architecture for Reliable Server Pooling,” <draft-ietf-rserpool-arch-07.txt>, Oct. 12, 2003.

RSerPool defines three types of architectural elements:
Pool Elements (PEs): servers that provide the same service within a pool;
Pool users (PUs): clients served by PEs;
Name Servers (NSs): servers that provide the translation service to the PUs and monitor the health of PEs.

In RSerPool, pool elements are grouped in a pool. A pool is identified by a unique pool name. To access a pool, the pool user consults a name server.

FIG. 1 schematically outlines the known RSerPool architecture. Before sending data to the pool (identified by a pool name), the pool user sends a name resolution query to the name (or ENRP, see below) server. The ENRP server resolves the pool name into the transport addresses of the PEs. Using this information, the PU can select a transport address of a PE to send the data to.

RSerPool comprises two protocols, namely, the aggregate server access protocol (ASAP) and the endpoint name resolution protocol (ENRP). ASAP uses a name-based addressing model which isolates a logical communication endpoint from its IP address(es). The name servers use ENRP for communication with each other to exchange information and updates about server pools. The instance of ASAP (or ENRP) running at a given entity is referred to as ASAP (or ENRP) endpoint of that entity. For example, the ASAP instance running at a PU is called the PU's ASAP endpoint.

Each time a PU sends a message to a pool that contains more than one PEs, the PU's ASAP endpoint must select one of the PEs in the pool as the receiver of the current message. The selection is done in the PU according to the current server selection policy (SSP). Four basic SSPs are currently being discussed to use with ASAP, namely, the Round Robin, Least Used, Least Used With Degradation and Weighted Round Robin, see R. R. Stewart, Q. Xie: Aggregate Server Access Protocol (ASAP), <draft-ietf-rserpool-asap-08.txt>, Oct. 21, 2003.

The simplified example sequence diagram in FIG. 2 schematically illustrates the event sequence when the PU's ASAP endpoint does a cache population [Stewart & Xie] for a given pool name and selects a PE according to the state of the art.

Cache population (update) means updating of the local name cache with the latest name-to-address mapping data as retrieved by the ENRP server.

The steps shown in FIG. 2 are explained as follows:

S1: The ASAP endpoint of the PU sends a NAME RESOLUTION query to the ENRP server asking for all information about the given pool name.

S2: The ENRP server receives the query and locates the database entry for the particular pool name. The ENRP server extracts the transport addresses information from the database entry.

S3: The ENRP server creates a NAME PESOLUTION RESPONSE in which the transport addresses of the PEs are inserted. The ENRP server sends the NAME RESOLUTION RESPONSE to the PU.

S4: The ASAP endpoint of the PU populates (updates) its local name cache with the transport addresses information on the pool name.

S5: The PU selects one of the Pool Elements of the Server Pool, based on the received address information.

Eventually, the PU accesses the selected Server for making use of the service/s.

The existing static server selection policies use predefined schemes for selecting servers. Examples of static SSPs are:
Round Robin is a cyclic policy, where servers are selected in sequential fashion until the initially selected server is selected again;
Weighted Round Robin is a simple extension of round robin. It assigns a certain weight to each server. The weight indicates the server's processing capacity.

The unawareness of dynamic system states leads to low complexity, however, at the expense of degrading performance and service dependability. Adaptive (dynamic) SSPs make decisions based on changes in the system state and dynamic estimation of the best server. Examples of dynamic SSPs are:
Least Used SSP: In this SSP, each server's load is monitored by the client (PU). Based on monitoring the loads of the servers, each server is assigned the so-called policy value, which is proportional to the server's load. According to the least used SSP, the server with the lowest policy value is selected as the receiver of the current message. It is important to note that this SSP implies that the same server is always selected until the policy values of the servers are updated and changed.
Least Used With Degradation SSP is the same as the least used SSP with one exception. Namely, each time the server with the lowest policy value is selected from the server set, its policy value is incremented. Thus, this server may no longer have the lowest policy value in the server set. This heads the least used with degradation SSP towards the round robin SSP over time. Every update of the policy values of the servers brings the SSP back to least used with degradation.

The effectiveness of a dynamic SSP critically depends on the metric that is used to evaluate the best server. The research on SSPs has been mainly focused on the replicated Web server systems. In such systems, the typical metrics are based on server proximity including geographic distance, number of hops to each server, round trip time (RTT) and HTTP response times. While SSPs in Web systems aim to provide high through- put and small service latency, for example, session control protocols such as SIP deal with messages being rather small in size (500 bytes on average). Thus, throughput is not an as significant metric as in the Web systems. To the best of the author's knowledge, SSPs have not been extensively investigated with, for example, the session control systems.

### SUMMARY OF THE INVENTION

The present invention relates to a method of providing a server function in support of a service or a set of services, such as internet-based applications, the server function provided by a Server Pool with one or more Pool Elements, each of the Pool Elements being capable of supporting the service/s, where the reliability and availability of the server function is improved over the existing methods, as well as to propose a name server and a pool user device implementing such a method.

In one embodiment, the present invention uses the message exchange between pool user and name server to provide the pool user with (additional) status information related to the pool elements from the name server. As the name server is a node dedicated to the server pool, in general it will possess better information concerning the status of the pool elements, regarding, for example, their current status as based on recent Keep-Alive-Messages.

At least the name server has additional status information at its disposal which, if provided to the pool user, in general offers the chance to make selection decisions resulting in improved performance, reliability and higher availability of the server functions to be performed by the elements of the server pool. Herewith, the response times as well as load situations of the server pool can be optimized.

In another embodiment, it is possible to provide to the server selection module of the pool user the status information from the name server, as in any case a message exchange is required for the pool user to retrieve the transport addresses of the pool elements.

The invention described herein thus proposes a RSerPool protocol extension, wherein the corresponding extension of the RSerPool architecture can easily be implemented on the name server and the Pool User.

According to still another embodiment of the invention, failure-detection mechanisms are distributed in the pool user and the name server. The pool user makes use of the application layer and transport layer timers to detect transport failure, while name servers provide the keep-alive mechanism to periodically monitor PE's health.

In yet another embodiment of the invention, a particular server selection policy called Maximum Availability SSP (MA-SSP), which is subject to a separate application of the applicant. The invention is however not limited to that MA-SSP but can be based on any static or dynamic SSP which is known or to be developed in the future.

The MA-SSP operates with the so-called status vector. According to the MA-SSP, a status vector is of size N (i.e., equal to the number of pool elements in a given server pool) and is defined as follows:
P=[P₁,P₂, . . . ,P_{N}]

A certain element in the status vector represents the last known status moment of the particular PE. If the last PE's status was ON (up), the time value is stored in the status vector unchanged. If the last PE's status was OFF (down), the time value is stored in the status vector with a negative sign. The MA algorithm always selects the PE that has the maximum value in the status vector.

The PU's ASAP endpoint accomplishes the updating of its status vector. Hereafter, the PU's status vector is denoted as p^{(U)}. According to the original RSerPool specification [Tuexen et al.; Stewart & Xie], a name server returns the transport addresses of the pool servers. In order to smoothly integrate, for example, the MA-SSP into the RSerPool architecture, a RSerPool extension is specified. This RSerPool extension, which can be used for other SSPs in rather the same way, is described in the following text.

The extension in RSerPool affects the communication between a PU and NS, namely, the NS's and the PU's ASAP endpoint. It is assumed here for illustrative purposes, that both the PU and the ENRP server employ the MA algorithm. The MA algorithm in the ENRP server creates a status vector for each server pool. This status vector is updated periodically by using the existing ASAP'S keep-alive mechanism [Stewart & Xie]. We will hereafter denote the name server's status vector as p^{(s)}. The p^{(s)} vector for a given pool is stored in the same database entry in the name server reserved for that pool. We will assume that there are N pool elements in the pool.

A PU initiates cache population in the following two cases:

1) The P′U wants to accomplish a cache population (update) in order to refresh its p^{(U)} vector with the newest information from the name server.

2) The PU wants to resolve a pool name.

In either case, the PU's ASAP endpoint sends a NAME RESOLUTION query to the ENRP server via ASAP. The ENRP server receives the query, and locates the database entry for the particular pool name. The database entry contains the latest version of the p^{(s)} vector. The ENRP server accomplishes the following actions:

1) The ENRP server extracts the transport addresses information from the database entry.

2) The ENRP server extracts the p^{(s)} vector from the data-base entry.

3) The ENRP server creates a NAME RESOLUTION RESPONSE in which the transport addresses of the PEs are inserted. In addition to the transport addresses information, the name response is extended with an extra field. The p^{(a)} vector is inserted into that extra field.

4) The ENRP server sends the NAME RESOLUTION RESPONSE to the PU.

Thus, the NAME RESOLUTION RESPONSE includes the most up-to-date version of the ENRP server's p^{(s)} vector. Once the PU receives the NAME RESOLUTION RESPONSE, it updates the local name cache (transport addresses information) as well as its p(u) vector. The procedure for updating the PU's ASAP p^{(u)} vector is as follows:

$${Pi}^{( u )} = \{ \begin{matrix}{Pi}^{( s )} , \vert {Pi}^{( s )} \vert > \vert {Pi}^{( u )} \vert \\ \vert {Pi}^{( u )} , \vert {Pi}^{( s )} \vert \leq \vert {Pi}^{( u )} \vert\end{matrix} \} i ∈ \{ 1 , … , N \} \qquad ( 1 )$$

where Pi^{(u)} and Pi^{(s)} are the i^{th} elements of p^{(u)} and p^{(s)}, respectively.

It should be noted that this works well under the condition of synchronized time clocks in pool users and name servers. This becomes an issue if the inter-clock drifts are intolerably large. Employing a clock synchronization protocol such as the network time protocol (NTP) eliminates this problem.

Advantageously, the protocol extension of RSerPool required for implementing the invention is rather simple and easy-to-introduce in RSerPool. Furthermore, the protocol extension is transparent to the application layer in the PU, i.e., the client. The status vector is handled at the ASAP layer of the PU protocol stack. Thus, the protocol extension is transparent to the application layer above the ASAP layer. Each PU supporting this protocol extension benefits from the performance improvements provided by the invention.

### BRIEF DESCRIPTION OF THE DRAWINGS

The invention is described below in more detail with reference to the exemplary embodiments and drawings, in which:

FIG. 1 shows a simplified block diagram the general RSerPool architecture according to the state of the art.

FIG. 2 shows a simplified sequence diagram illustrating a message exchange between pool user and name server from FIG. 1 according to the state of the art.

FIG. 3 shows a sequence diagram as in FIG. 2, illustrating a message exchange between name server and pool user according to an embodiment of the inventive method.

FIG. 4 shows a block diagram showing the essential functional blocks of name server and pool user device relevant for implementing the embodiment of the invention illustrated in FIG. 3.

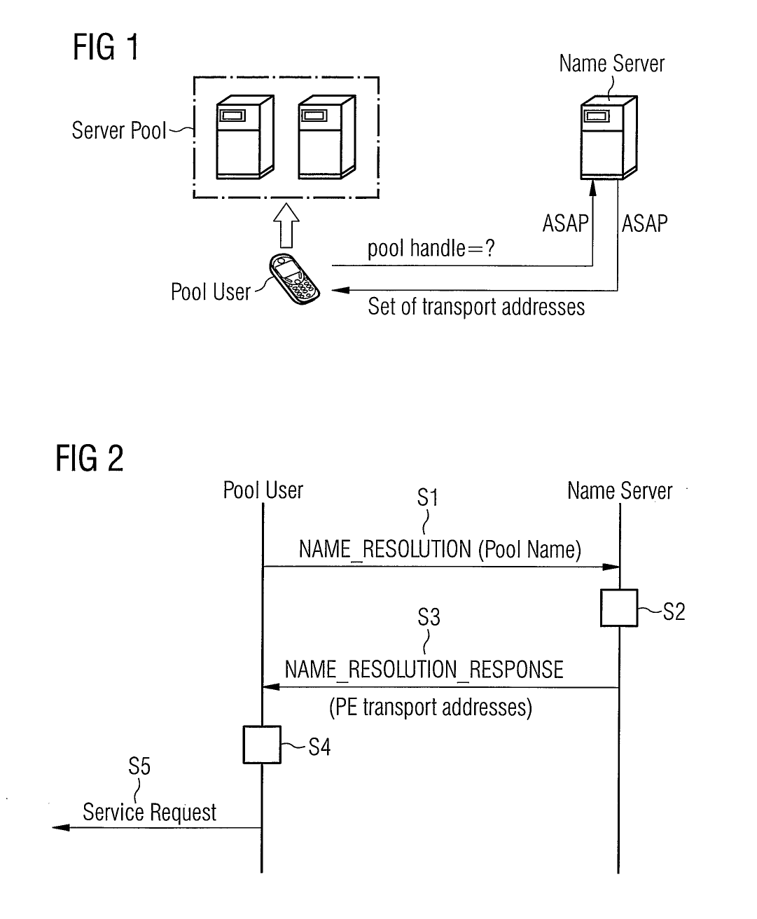

### DETAILED DESCRIPTION OF THE INVENTION

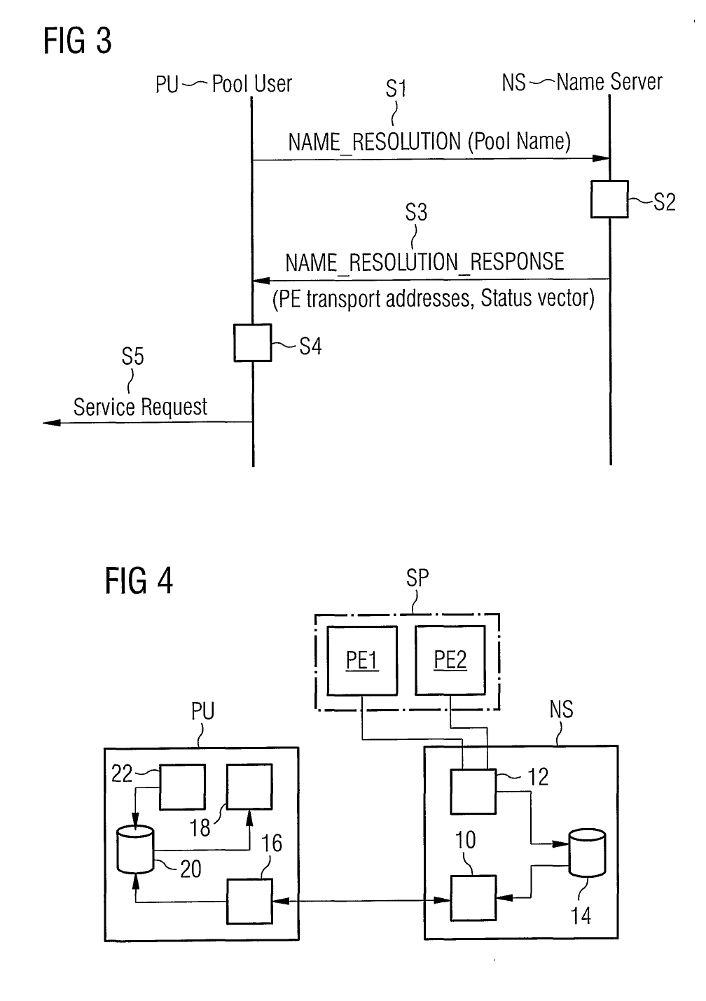

A schematic drawing summarizing the basic principle of the invention is shown in FIG. 3. The steps S1-S4 for the cache population as defined in this invention are explained as follows:
1) Sending of a NAME RESOLUTION query from the ASAP endpoint of a Pool User PU to a name or ENRP server NS, asking for all information about a given pool name.
2) Receiving of the query, and locating of a database entry for the particular pool name by the name server NS. The name server NS extracts from the database entry the transport addresses information as well as the p^{(S)} vector.
3) Creating a NAME RESOLUTION RESPONSE, in which the transport addresses of the PEs and the p^{(s)} vector are inserted, by the name server NS. The name server NS sends the NAME RESOLUTION RESPONSE to the pool user PU.
4) Cache population (Updating) of its local name cache by the ASAP endpoint of the pool user PU with the transport addresses information on the pool name. The pool user's ASAP endpoint applies the simple procedure described above in equation (1) to update the status vector p^{(u)}.
5) Selection of a particular pool element or server for sending a service request to.

The implementation of the inventive method can be performed quite straightforwardly. The NAME RESOLUTION RESPONSE is extended with a separate field that contains the status vector p^{(s)}. FIG. 4 shows the principal functional components of the pool user PU and name server NS, the latter being associated to a Server Pool SP with two Pool Elements PE illustrated.

The name server NS comprises a pool resolution server module 10, an element status module 12 and a memory 14. The element status module 12 periodically assembles Endpoint-Keep-Alive-messages according to the IETF ASAP Protocol [Stewart & Xie] and sends these messages to each of the servers PE1, PE2. Assuming the server PE1 being in the operational status “up” (server PE1 is ready to provide a server function on request of, for example, the client PU), server PE1 responds to the Keep-Alive-Message from the server NS by sending an Endpoint-Keep-Alive-Ack-message back to the name server NS.

Assuming further the server PE2 being in the operational status “down” (server PE2 is not ready for service), server PE2 does not respond to the Keep-Alive-Message from the name server NS thereby the local timer initiated for that Keep-Alive-Message at the name server NS expires according to the IETF ASAP Protocol.

The element status module 12 maintains a status vector, which is stored in the memory 14. The vector contains for each element PE1, PE2 of the Pool SP a number representing a timestamp, which indicates the time of processing of the response of each of the elements to the Keep-Alive-Message. The Keep-Alive-Ack-Message received from PE1 thus leads the module 12 to write a timestamp ‘A8C0’ (hex) into the position of the status vector provided for server PE1, assuming the Ack-Message has been processed at twelve o'clock as measured by a clock unit (not shown) in the name server and the timestamp accuracy is in units of seconds. The Unreachable-Message received from PE1 leads the module 12 to write a timestamp ‘−A8C1’ (hex) into the position of the status vector provided for server PE2, assuming the Unreachable-Message has been processed around one second after twelve o'clock.

The functionality of the server module 10 is described below in more detail with regard to a request from the Pool User PU. The Pool User PU comprises a pool resolution client module 16, a server selection module 18, a memory 20 and a server availability module 22.

The pool user PU is implemented on a mobile device (not shown) capable for data and voice communication via a UMTS-network, the server pool SP and name server NS being parts thereof. An application of the device wants to access a service provided by any one of the servers of the Pool SP. In this example, the server pool SP is a farm or set of servers implementing services related to the IMS(IP Multimedia Subsystem)-domain of the UMTS network. The application is for example a SIP-based application.

To request a particular service, only the Pool Name is known to an application running on the mobile device (not shown). The application triggers the Pool User part (comprising the ASAP endpoint) of the mobile device by handing over the Pool Name. The pool resolution client module assembles a Name-Resolution-Message according to the ASAP protocol and sends it to the name server NS (step S1 in FIG. 3).

The Name-Resolution-Message is received in the name server NS by the pool resolution server module 10. The pool name is extracted and the server module 10 accesses the memory 14 to extract the address information which is stored associated to the Pool Name. In the example, the IP-addresses of the pool elements PE1, PE2 are read from the memory 14, in conjunction with the port address to be used for requesting the particular service, and, according to the invention, also the timestamps ‘A8C0’, ‘−A8C1’ stored in association to the servers PE1, PE2 are read from the memory 14. The step S2 of FIG. 3 is then finished.

The server module 10 assembles a Name Resolution Response-Message according to the IETF ASAP protocol, which contains the Name Resolution List with the transport addresses of PE1, PE2, as is known in the art. Further, a status vector is appended to the transport address information part of the Response-message. The vector comprises in this example the two timestamp-based status-elements for the pool servers PE1, PE2.

The Response-Message is being sent to the sender of the request (step S3 in FIG. 3), i.e. to the client module 16 of the Pool User PU. After receiving the Response-Message, the module 16 extracts transport addresses and the status vector from the Response-Message and writes the data to the memory 20. Further, the module hands control over to the server selection module 18.

To select a particular server for sending the service request to (i.e. performing step S5 of FIG. 3), the selection module 18 first loads two status vectors into work memory, a first one which has been determined by the server availability module 22, the second one being the status vector received from the name server as described above.

The server availability module 22 determines status information related to an availability of one or more of the Pool Elements and accesses the memory 20 to write the status information thereto. In particular, the module 22 determines a positive timestamp value for each time, a timer for a message transaction on transport and on application layer does not expire, i.e. the respective transaction has been successfully completed by reception of an acknowledgment, response or other reaction from the Pool Server. In case a timer related to a transport or application connection to a server expires (i.e. no answer received in time), the negative of the current timestamp value at timer expiry is written to the first status vector determined locally by the availability module 22.

As mentioned above, the selection module 18 loads both status vectors. Next, the module 18 determines an updated local status vector by replacing each entry in the local status value with the corresponding value of the name server status vector, in case this corresponding value in absolute terms (i.e., ignoring a ‘−’ sign) is higher, which means, that the status measurement by the name server is more up-to-date, i.e., has been performed more recently, than the status measurement performed locally by the availability module 22.

As an example, the stored local (first) status vector might represent the status of PE1 at 11:50 (unreachable) and 11:55 (reachable), i.e., <−A668,A794>, then the local vector is updated in both positions, resulting in <A8C0,−A8C1>.

The updated vector is written back to the memory into the position of the local vector. The storage position for the vector received from the name server NS might be used for different purposes inside the mobile device.

In a further step (step 5 in FIG. 3), the server selection module 18 determines the server to be selected by evaluating the highest value in the updated status vector. In this example, the highest value is ‘A8C0’, being stored in the position denoting the pool element PE1. Thus the module 18 creates a pointer pointing towards the storage position inside the memory 20 containing the transport address and further data, such as port address, related to PE1, and returns this pointer back to the calling application to enable it to request the service from PE1.

The specific example described herein illustrates just one appropriate embodiment of the invention. Within the scope of the invention, which is exclusively specified by the appended claims, by skilled action many further embodiments are possible.

For example, the devices and modules as described herein may be implemented as Hardware or Firmware. Preferably, however, they are implemented as Software. For example, the Pool User device comprising the or any further modules as described above may be implemented on a mobile device as an applet.

1. A method of providing a reliable server function in support of a service, such as internet-based applications, the method comprising:
forming a server pool with one or more pool elements, each of the pool elements being capable of supporting the service,
providing at least one name server for managing and maintaining a name space for the sewer pool, the name space comprising a pool name identifying the sewer pool,
sending, by a pool user for making use of the service, a request to the name server indicating the pool name,
resolving, by the name server upon request, the pool name to a Name Resolution List, the Name Resolution List comprising address information, including at least an IP address, related to one or more of the pool elements,
sending the Name Resolution List by the name server to the pool user,
accessing, by the pool user and based on the address information from the Name Resolution List, one of the pool elements of the server pool for making use of the service,
wherein status information related to the operational status of at least one of the pool elements is sent from the name server to the pool user,
the pool user determines a status vector comprising status information related to an availability of one or more of the pool elements and the status vector determined by the pool user is updated by the status vector received from the name server and
the status information related to the availability is determined by the expiry or non-expiry of one or more timers related to message transmission between the pool user and the one or more of the pool elements in one of an application layer and a transport layer.

2. The method of claim 1, wherein the status information represents a timestamp indicating a point of time at which the status of one of the pool elements is determined.

3. The method of claim 2,
wherein the status of said one of the pool elements is determined based on a Keep-Alive-Acknowledgement-Message received by the name server from the one of the pool elements in response to a Keep-Alive-Message sent by the name server to the one of the pool elements or a local timer expiry notification at the name server due to a missing Keep-Alive-Acknowledgement-Message from one of the pool elements, the Keep-Alive-Acknowledgement-Message and the local timer expiry notification indicating the status of the one of the pool elements, for example as being up and down, respectively.

4. The method of claim 2,
wherein the status information comprises a positive number, representing the timestamp, if said one of the pool elements is in an up-status and the status information comprises a negative number, representing the timestamp with a minus sign, if said one of the pool elements is in a down-status.

5. The method of claim 1,
wherein the sending of the request by the pool user to the name server is performed by sending a name Resolution Message, the sending being triggered within the pool user to accomplish cache population.

6. The method of claim 1,
wherein sending the name Resolution List by the name sewer (NS) to the pool user (PU) comprises sending a name Resolution Response Message, which further comprises the status information, whereby the status information is inserted into the name Resolution Response Message as a status vector.

7. The method of claim 1,
wherein a particular one of the pool elements in the server pool is selected for the server function, based on the status information in the status vector received from the name server.

8. The method of claim 1,
wherein the status vector determined by the pool user is updated by replacing status information with corresponding status information of the status vector received from the name server, if the corresponding status information is indicated to be more up-to-date.

9. The method of claim 5,
wherein in selecting a particular one of the pool elements in the server pool, by the pool user, a server selection policy is applied.

10. A name server for managing and maintaining a name space for a server pool with one or more pool elements for providing a reliable server function in support of a service, the name server comprising:
a pool resolution server module to receive a name Resolution Message request according to the IETF ASAP protocol, indicating the pool name, and
a memory to store address information, including an IP address, related to the pool elements associated to a pool name identifying the server pool, the pool resolution server module being adapted to resolve, in response to the request, the pool name to a name Resolution List by accessing the memory and extracting the address information associated to the pool name thereof, and to assemble a message comprising the Name Resolution List according to the IETF ASAP protocol, and to send the message to the sender of the request,
wherein the memory is further adapted to store status information associated to one or more of the pool elements and the pool resolution server module is further adapted to access, in response to the request, the memory to extract the status information, and to send the status information back to the sender of the request, preferably by inserting the status information into the message as a status vector.

11. The name server of claim 10,
wherein an element status module is provided to assemble a Keep-Alive-Message according to the IETF ASAP Protocol, and to send the Keep-Alive-Message to one of the pool elements, and to receive a Keep-Alive-Acknowledgement-Message or to receive a local timer expiry notification, according to the IETF ASAP Protocol, from one of the pool elements and, in response to this reception, to access the memory to write status information indicating the status of said one of the pool elements, as being up or down, respectively.

12. The Name server of claim 11,
wherein the element status module is adapted to write as the status information a number representing a timestamp.

13. A pool user device for making use of a server function in support of a service which can be provided by each one of one or more pool elements of a server pool, the pool user device comprising:
a pool resolution client module to assemble a request,
according to the IETF ASAP protocol, indicating a pool name identifying the server pool, to send this request to a name server and to receive a message comprising a name resolution list, according to the IETF ASAP protocol from the name server,
a server selection module to access, based on address information from the name resolution list, a particular one of the pool elements of the server pool for making use of the service,
wherein the pool resolution client module is further adapted to receive the message comprising a status vector and the server selection module is further adapted to access the particular one of the pool elements in response to status information included in the status vector and that resolution client module is adapted to determine a status vector comprising status information related to an availability of one or more of the pool elements and to update the status vector determined by the pool user by the status vector received from the name server and the pool resolution client module is adapted to determine the status information related to the availability by the expiry or non-expiry of one or more timers related to message transmission between the pool user and the one or more of the pool elements in one of an application layer and transport layer.

14. The pool user device of claim 13,
wherein by a memory to store status information, preferably a status vector, where the pool resolution client module and the server selection module are adapted to write and read, respectively, the status information.

15. The pool user device of claim 14,
further comprising a server availability module to determine status information related to an availability of one or more of the pool elements and to access the memory to write the status information thereto.

16. The pool user device of claim 15,
wherein the server selection module is adapted to update the status vector written by the server availability module to the memory by the status vector received by the pool resolution client module.

17. The pool user device of claim 13,
wherein in selecting a particular one of the pool elements in the server pool (SP), by the server selection module a server selection policy is applied.
